(19) United States
(12) Patent Application Publication
(10) Pub. No.: US 2010/0146595 A1
(43) Pub. Date: Jun. 10, 2010

(54) NETWORKING COMPUTERS ACCESS CONTROL SYSTEM AND METHOD

(75) Inventor: Victor I. Sheymov, Vienna, VA (US)

Correspondence Address: ROBERTS MLOTKOWSKI SAFRAN & COLE, P.C.;Intellectual Property Department, P.O. Box 10064, MCLEAN, VA, 22102-8064, US

(73) Assignee: INVICTA NETWORKS, INC, Reston, VA (US)

(21) Appl. No.: 12/594,717

(22) PCT Filed: Apr. 3, 2008
(86) PCT No.: PCT/US08/59232

§ 371 Date: Jan. 14, 2010

Related U.S. Application Data
(60) Provisional application No. 60/907,503, filed on Apr. 5, 2007.

(51) Int. Cl. G06F 21/00

(52) U.S. Cl. 726/4

(57) ABSTRACT

A method, system, and device for controlling access for networking computers or devices, including a controller (112, 126) that controls access to a communications network or system (102, 116) including networking computers or devices, wherein computers or devices or entities that can be granted access to the network or system are on a push file or list, and those that can be granted access based on an access request to the controller are on a pull file or list. The controller grants or denies access based on the push file or list without receiving the access request, grants or denies access based on the pull file or list, only after receiving the access request, and with proper jurisdiction and otherwise sends the access request to a higher level controller with jurisdiction over the controller. The process is repeated until the access request is granted or denied.

### CROSS REFERENCE TO RELATED DOCUMENTS

The present invention claims benefit of priority to U.S. Provisional Patent Application Ser. No. 60/907,503 of Sheymov, entitled “NETWORKED COMPUTERS ACCESS CONTROL SYSTEM AND METHOD,” filed on Apr. 5, 2007, the entire disclosure of which is hereby incorporated by reference herein.

### BACKGROUND OF THE INVENTION

1. Field of the Invention

The present invention generally relates to system and methods for access control, and more particularly to a system and method for improved access control for networking computers, devices, and the like.

2. Discussion of the Background

In recent years, computer and network access control systems have found more and more real world applications. For example, a Systems Control And Data Acquisition (SCADA) system includes an access control system used as a control and management solution in a wide range of critical industries, such as water management systems, gas and electric power distribution systems, traffic signaling systems, mass transit systems, environmental control systems, manufacturing systems, financial infrastructure systems, and the like. Similarly, an InvisiLAN system or network includes an access control system that employs Variable Cyber Coordinates (VCC) for a transmitter and receiver and which are not constant, but rather are constantly, and rapidly changing, wherein new coordinates are communicated only to authorized parties. The Cyber Coordinates can include any suitable address, such as a computer IP address or port, a telephone number, a Media Access Control (MAC) address, Ethernet Hardware Address (EHA), and the like, employed in any suitable communications system or network, and the like.

Accordingly, the above systems can be used to create an access control system for a computer or network. However, such systems may often employ access control mechanisms that can either have limited scalability or too broad of controls, which sometimes can be detrimental for security.

### SUMMARY OF THE INVENTION

Therefore, there is a need for a method, system, and device that address the above and other problems with access control systems or networks. The above and other needs are addressed by the exemplary embodiments of the present invention, which provide a method, system, and device for improved access control for networking computers, devices, and the like.

Accordingly, in exemplary aspects of the present invention, a method, system, and device for controlling access for networking computers or devices are provided, including a controller that controls access to a communications network or system, including one or more networking computers or devices; a push file or list including computers or devices or entities that can be granted access to the network or system; and a pull file or list including computers or devices or entities that can be granted access to the network or system based on an access request to the controller, wherein the controller grants or denies access to the computers or devices or entities on the push file or list without receiving the access request, the controller grants or denies access to the computers or devices or entities on the pull file or list, only after receiving the access request, and only if the computers or devices or entities on the pull file or list that requested the access are within control or jurisdiction of the controller, if the computers or devices or entities on the pull file or list that requested the access are not within the control or jurisdiction of the controller, the controller sends the access request to a higher level controller that has control or jurisdiction over the controller sending the access request, and the above process is repeated until the computers or devices or entities on the pull file or list that requested the access are granted or denied access to the network or system

Still other aspects, features, and advantages of the present invention are readily apparent from the following detailed description, simply by illustrating a number of exemplary embodiments and implementations, including the best mode contemplated for carrying out the present invention. The present invention also is capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings, in which like reference numerals refer to similar elements, and in which:

FIG. 1 illustrates an exemplary access control system for describing the exemplary embodiments;

FIG. 2 illustrates an exemplary “push” type of access control;

FIG. 3 illustrates an exemplary “pull” type of access control;

FIG. 4 illustrates an exemplary “auto push/pull” access control;

FIG. 5 illustrates an exemplary controller hierarchy for access control; and

FIG. 6 illustrates an exemplary “auto push/pull” access control process.

### DETAILED DESCRIPTION

The present invention includes recognition that networking computers access control systems usually have either a limited scalability or too broad categories of controls, sometimes being detrimental for security. Accordingly, the exemplary embodiments can eliminate such restrictions, advantageously, allowing unlimited scalability of control, combined with a fine granularity of access, as desired.

The exemplary embodiments can be applied to any suitable access control communications network or system, such as a Systems Control And Data Acquisition (SCADA) system, an InvisiLAN system, and the like. The InvisiLAN system is further described on the World Wide Web (e.g., at invictanetworks.com/pdf/invisilantech.pdf). However, the teachings of the exemplary embodiments are applicable to other types of networks or systems where there is a need for robust access control, as will be appreciated by those skilled in the relevant art(s).

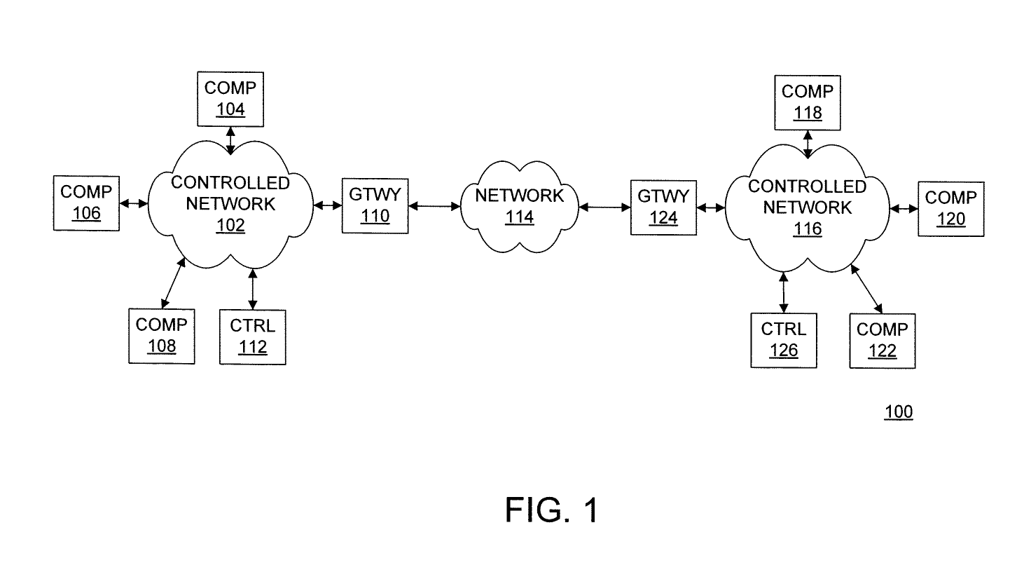

Referring now to the drawings, FIG. 1 thereof illustrates an exemplary system 100 for robust access control and for addressing the above and other problems with access control communications networks or systems. In FIG. 1, a secure communications network or system 102 includes one or more computers or computing devices 104-108, a gateway 110 (e.g., a router, a computer, etc.), and a controller 112 for providing access control for secure communication with another secure communications network or system 116 over an unsecured network 114, such as the Internet. Similarly, the secure communications network or system 116 includes one or more computers or computing devices 118-122, a gateway 124 (e.g., a router, a computer, etc.), and a controller 126 for providing access control for secure communication with the secure communications network or system 102 over the unsecured network 114. Examples of the systems 102 and 116 can include any suitable access control communications networks or systems, such as Systems Control And Data Acquisition (SCADA) systems, InvisiLAN systems, and the like.

The present invention includes recognition that there are various aspects of networking computers access control that may impact a system's scalability. For example, one aspect is the delivery of “enabling” information to a computer. Such enabling information can include any suitable information employed to conduct a particular communication between two or more computers, such as VCCs (Variable Cyber Coordinates) of the InvisiLAN system, such as the IP address, port number, MAC address, as well as authentication and encryption keys, passwords, and the like. This enabling information delivery is applicable to legacy, static access control systems, and more advanced dynamic systems, such as the VCC-based InvisiLAN systems, and the like.

In either type of system, however, there is a contradiction between granularity of control and scalability. In other words, the finer the granularity of the access control that is employed, the larger the amount of the enabling information that is to be sent through the network. Such effect is even more pronounced for dynamic systems, such as the InvisiLAN systems, and the like. Typically, such enabling information is computed, stored, and distributed by a controlling entity, such as a control unit of a system (e.g., the control units 112 or 126 of FIG. 1, control units of the InvisiLAN systems, and the like). Such a controller sends the enabling information to one or more computers under its jurisdiction (e.g., the computers 104-108 and 118-122 of FIG. 1, the computers in the InvisiLAN systems, and the like).

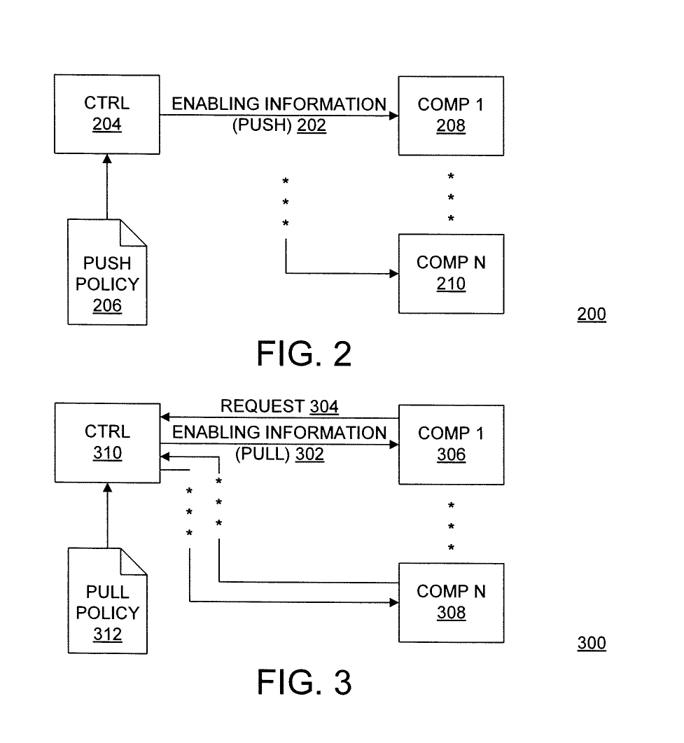

This enabling information can be delivered to networking computers in various ways. For example, as illustrated in subsystem 200 of FIG. 2, enabling information 202 can be “pushed,” for example, sent by a controller 204 based on an access control policy 206 without regard whether or not one or more particular computers 208-210 need such particular information at that time. Alternatively, as illustrated in subsystem 300 of FIG. 3, enabling information 302 can be “pulled,” (e.g., sent only if requested and ending at some point upon time expiration or event, and the like). For example, based on a request 304 from one or more particular computers 306-308 based on their need to communicate, and sent by a controller 310, if the one or more computers are allowed access based on an access control policy 312.

The push type system 200 has a disadvantage of typically employing a significant volume of control information, thus consuming network bandwidth. An advantage of the system 200, however, is that networking computers 208-210 have the enabling information 202 readily available, and can initiate communications immediately, even if communications with the controller 204 is interrupted.

The pull type system 300, on the other hand, sends the enabling information 302 as needed, avoiding sending a massive amount of information, which may never be used. Accordingly, the system 300 has the advantage of minimizing the volume of control information transmission employed. A disadvantage of the system 300, however, is that the enabling information request 304 and transmission of the enabling information 302 can require more time than with the push type system 200. This extra time may not be available for some systems, such as systems controlling highly dynamic processes. In addition, if the establishing of immediate communications for one or more of the communicating computers 306-308 is crucial, the risk of a communications failure with the controller 310 may be unacceptable. Furthermore, with devices that are constantly communicating, constant pull requests can actually consume even more bandwidth.

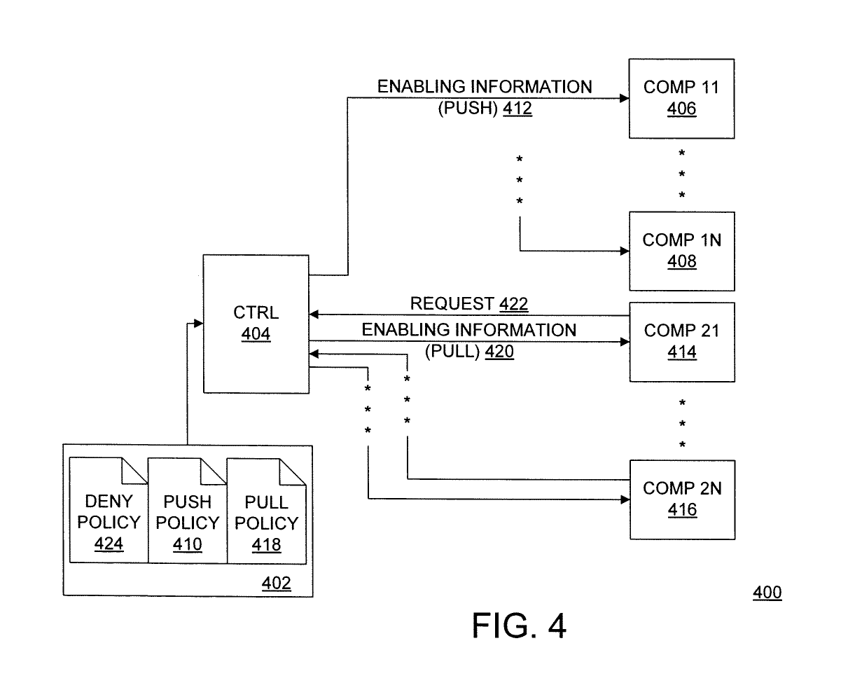

Recognizing the advantages and disadvantages of the push type system 200 and the pull type system 300, a further exemplary embodiment includes an “auto push-pull” system, as illustrated in subsystem 400 of FIG. 4, and that advantageously, employs the positive factors from both the systems 200 and 300, while at the same time avoiding their pitfalls. In an exemplary embodiment, a policy 402 of a controller 404 of the exemplary auto push-pull system 400 specifies one or more computers 406-408 connections that are critical in their nature, and/or in the timing thereof, and the like. Such computers 406-408 are put on a “push” distribution list 410 of the policy 402 and are supplied corresponding enabling information 412. Usually, the computers 406-408 would comprise a small percentage of the computers in a typical network. The other computers 414-416 can be placed on a “pull” list 418 of the policy 402 and are supplied enabling information 420, for example, based on a request 422, and in accordance with the access control policy 402. In addition, one or more computers can be placed on a “deny” list 424 of the policy 402 and which, for example, are not supplied with any enabling or other information in accordance with the access control policy 402. In addition, in order for constant pull requests to not consume unnecessary bandwidth for devices that are constantly communicating, advantageously, a pull device can become a push device and visa versa, as needed, and for example, until cancelled or expired, and the like.

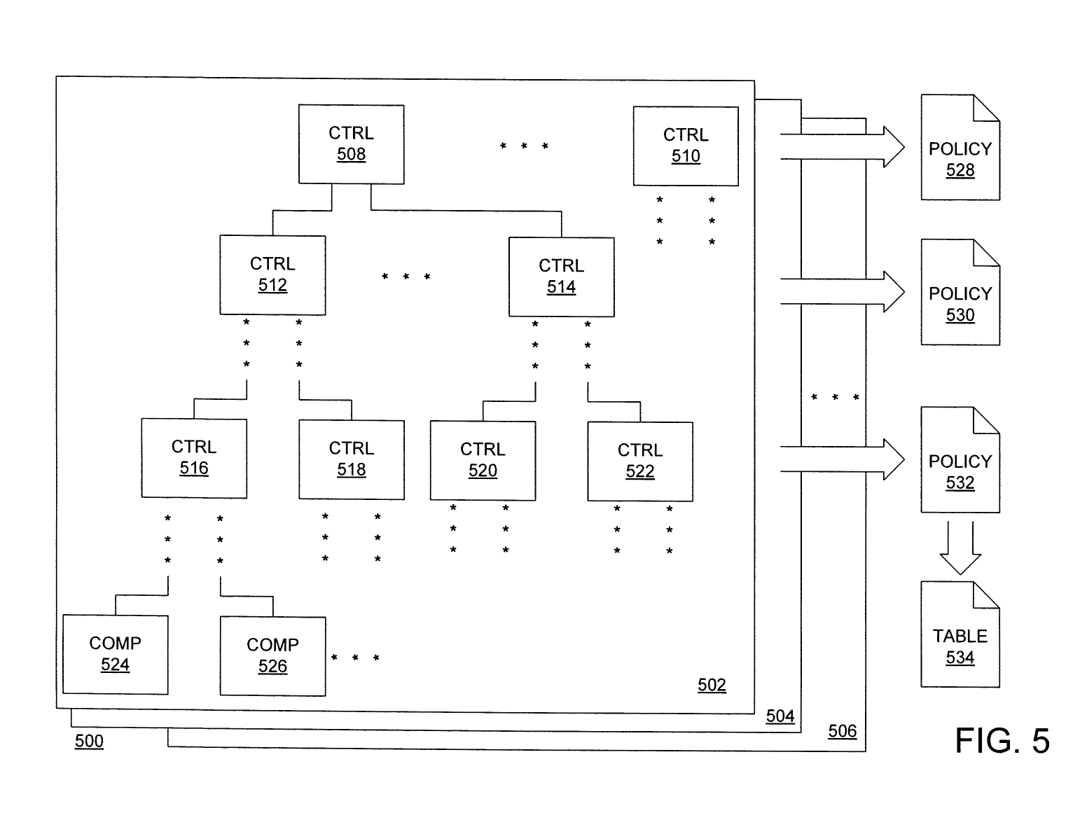

The other aspect affecting access control scalability is the mechanism of the access permission decisions. Typical organizational charts are pyramidal with a hierarchical structure. Accordingly, in an exemplary embodiment, as illustrated in subsystem 500 of FIG. 5, an organization's network computer access control system 500 can be built using a similar structure. In addition, such exemplary structure 500 can be multidimensional with dimensions 504-506, for example, due to complex requirements for information handling within the organization. For example, if an organization is a government entity and classified information is involved, the information control requirements can reflect not only the organizational structure per se, but also the information classification matters, which need not necessarily follow the hierarchy of the organization. In addition, an organization can run several large projects at any point in time, and participation in such projects may demand additional access control requirements and which the exemplary system 500, advantageously, can accommodate.

Such an environment can be very demanding on the access control decisions and their implementation. A compromise may either err on the “broad brush” side, where the access control policy can be too broad for effective control, or it can err on the “fine brush” side, where the access control policy can be too fine for effective control. For example, when decisions are made with fine granularity, the access control can become extremely cumbersome, and which may require a large database for such control, and which can be a difficult task, in it of itself.

Accordingly, in the exemplary system 500, the access control decisions can be made in a hierarchical manner. For example, an upper level of the access control system 500 can be made up of controllers 508-510 (and their counterparts in dimensions 504-506), which are essentially “controller(s) of the controller(s),” and which can establish a broadly based access control policy 528. The policy 528 is communicated to a next level of downstream controllers 512-514 (and their counterparts in dimensions 504-506). The downstream controllers 512-514 accept the policy 528 and can further refine the policy 528, as is pertinent to peculiarities of the part of the system 500 under their respective “jurisdiction” or control. The second-tier controllers 512-514, in turn, communicate the refined policy 530 to the next level down of controllers 516-522 (and their counterparts in dimensions 504-506), if any, and so on, to the lowest level controllers (and their counterparts in dimensions 504-506), which actually control one or more communicating computers 524-526 (and their counterparts in dimensions 504-506). The lowest level controllers 516-522 implement their refined policy 532 of the access control policy 530 communicated to them from the higher level controllers 512-514, and make, for example, a table 534 of actual access permissions for the computers 524-526 (and their counterparts in dimensions 504-506) under their control.

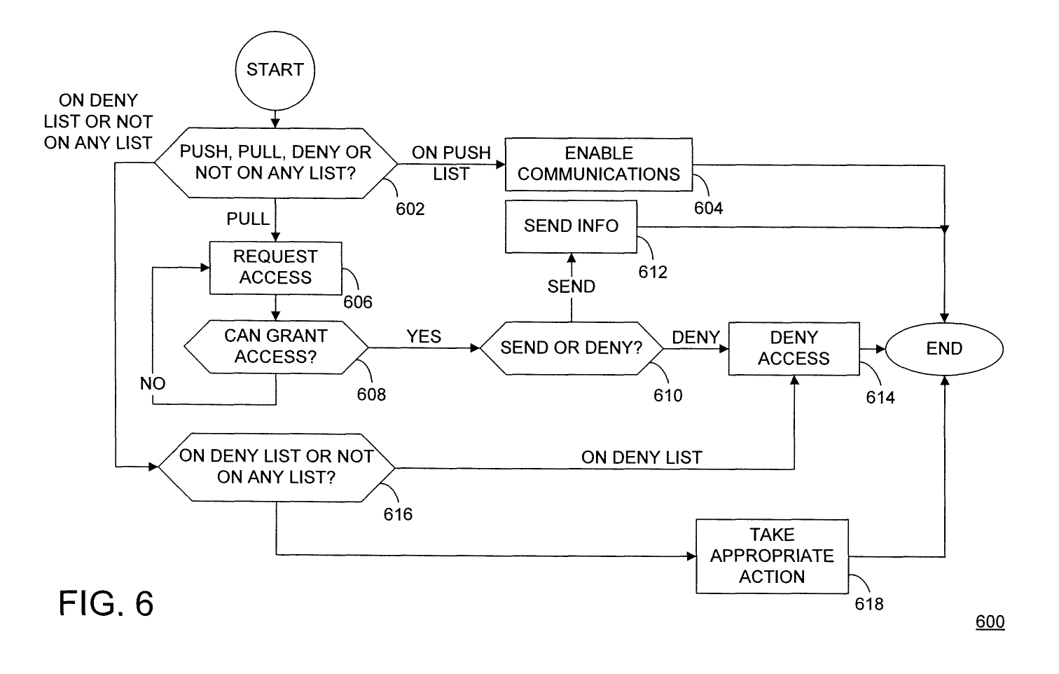

In an exemplary access control process 600, as illustrated in FIG. 6, when a computer needs to communicate with another computer, either the intended addressee (or the computer) can be on the “push” list 410, the “pull” list 418, the “deny” list 424 or not on any list at all, as determined by steps 602 and 616. If the intended addressee is on the “push” list 410, the communications commence immediately at step 604, since the “enabling” information is readily available. If, however, the intended addressee is on the “pull” list 418, the computer has to direct an access request to its immediate controller at step 606. If the immediate, lowest level controller, has a definite answer, as determined by step 608, the controller, as determined at step 610, either sends the “enabling” information at step 612, or denies the access at step 614, completing the process. If, on the other hand, the request falls in a category outside of its “jurisdiction” or control, as determined in step 608, the controller relays the request to the next upstream controller at step 606. If the intended addressee is determined to be on the “deny” list 424, as determined at step 616, the controller denies the access at step 614. If, however, the intended addressee is determined not to be on any list at all, as determined at step 616, the controller determines an appropriate action to take at step 618 (e.g., including denying access, reporting the unlisted intended addressee, placing the unlisted intended addressee on one of the push, pull or deny lists, taking any suitable action based on policy, and the like). The exemplary process 600 can be reiterated, for example, until the appropriate level of “jurisdiction” or control is reached and the access permission is either granted or denied.

The exemplary embodiments thus provide a flexible decision making access control mechanism, combined with an optimal “enabling” of an access control information delivery mechanism. Advantageously, the exemplary embodiments can be scaled, in a practical way, for current and future computing and communications environments.

The above-described devices and subsystems of the exemplary embodiments can be accessed by or included in, for example, any suitable clients, workstations, PCs, laptop computers, PDAs, Internet appliances, handheld devices, cellular telephones, wireless devices, other devices, and the like, capable of accessing or employing the new architecture of the exemplary embodiments. The devices and subsystems of the exemplary embodiments can communicate with each other using any suitable protocol and can be implemented using one or more programmed computer systems or devices.

One or more interface mechanisms can be used with the exemplary embodiments, including, for example, Internet access, telecommunications in any suitable form (e.g., voice, modem, and the like), wireless communications media, and the like. For example, employed communications networks or links can include one or more wireless communications networks, cellular communications networks, cable communications networks, satellite communications networks, G3 communications networks, Public Switched Telephone Network (PSTNs), Packet Data Networks (PDNs), the Internet, intranets, WiMax Networks, a combination thereof, and the like.

It is to be understood that the devices and subsystems of the exemplary embodiments are for exemplary purposes, as many variations of the specific hardware used to implement the exemplary embodiments are possible, as will be appreciated by those skilled in the relevant art(s). For example, the functionality of one or more of the devices and subsystems of the exemplary embodiments can be implemented via one or more programmed computer systems or devices.

To implement such variations as well as other variations, a single computer system can be programmed to perform the special purpose functions of one or more of the devices and subsystems of the exemplary embodiments. On the other hand, two or more programmed computer systems or devices can be substituted for any one of the devices and subsystems of the exemplary embodiments. Accordingly, principles and advantages of distributed processing, such as redundancy, replication, and the like, also can be implemented, as desired, to increase the robustness and performance of the devices and subsystems of the exemplary embodiments.

The devices and subsystems of the exemplary embodiments can store information relating to various processes described herein. This information can be stored in one or more memories, such as a hard disk, optical disk, magneto-optical disk, RAM, and the like, of the devices and subsystems of the exemplary embodiments. One or more databases employed with the devices and subsystems of the exemplary embodiments can store the information used to implement the exemplary embodiments of the present inventions. The databases can be organized using data structures (e.g., records, files, tables, arrays, fields, graphs, trees, lists, and the like) included in one or more memories or storage devices listed herein. The processes described with respect to the exemplary embodiments can include appropriate data structures for storing data collected and/or generated by the processes of the devices and subsystems of the exemplary embodiments in one or more databases thereof.

All or a portion of the devices and subsystems of the exemplary embodiments can be conveniently implemented using one or more general purpose computer systems, microprocessors, digital signal processors, micro-controllers, and the like, programmed according to the teachings of the exemplary embodiments of the present inventions, as will be appreciated by those skilled in the computer and software arts. Appropriate software can be readily prepared by programmers of ordinary skill based on the teachings of the exemplary embodiments, as will be appreciated by those skilled in the software art. Further, the devices and subsystems of the exemplary embodiments can be implemented on the World Wide Web. In addition, the devices and subsystems of the exemplary embodiments can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware circuitry and/or software.

Stored on any one or on a combination of computer readable media, the exemplary embodiments of the present inventions can include software for controlling the devices and subsystems of the exemplary embodiments, for driving the devices and subsystems of the exemplary embodiments, for enabling the devices and subsystems of the exemplary embodiments to interact with a human user, and the like. Such software can include, but is not limited to, device drivers, firmware, operating systems, development tools, applications software, and the like. Such computer readable media further can include the computer program product of an embodiment of the present inventions for performing all or a portion (if processing is distributed) of the processing performed in implementing the inventions. Computer code devices of the exemplary embodiments of the present inventions can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present inventions can be distributed for better performance, reliability, cost, and the like.

As stated above, the devices and subsystems of the exemplary embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

While the present inventions have been described in connection with a number of exemplary embodiments, and implementations, the present inventions are not so limited, but rather cover various modifications, and equivalent arrangements, which fall within the purview of claims of the present invention.

1. A system for controlling access for networking computers or devices, the system comprising:
a controller that controls access to a communications network or system, including one or more networking computers or devices;
a push file or list including computers or devices or entities that can be granted access to the network or system; and
a pull file or list including computers or devices or entities that can be granted access to the network or system based on an access request to the controller,
wherein the controller grants or denies access to the computers or devices or entities on the push file or list without receiving the access request,
the controller grants or denies access to the computers or devices or entities on the pull file or list, only after receiving the access request, and only if the computers or devices or entities on the pull file or list that requested the access are within control or jurisdiction of the controller,
if the computers or devices or entities on the pull file or list that requested the access are not within the control or jurisdiction of the controller, the controller sends the access request to a higher level controller that has control or jurisdiction over the controller sending the access request, and
the processing of the pull file or list is repeated until the computers or devices or entities on the pull file or list that requested the access are granted or denied access to the network or system.

2. The system of claim 1, wherein the system includes plural levels of controllers with an access control policy associated with each level, and an access control policy for a lower level is subordinate to an access control policy for a higher level.

3-11. (canceled)

12. The system of claim 1, further comprising a deny file including computers or devices or entities that are not allowed access to the network or system,
wherein the controller denies access to the computers or devices or entities on the deny file or list and computers or devices or entities that are not on the push file or list, and the pull file or list.

13. The system of claim 12, wherein the push file or list, the pull file or list, and the deny file or list comprise individual or separate files or lists.

14. The system of claim 12, wherein the push file or list, the pull file or list, and the deny file or list are stored on individual or separate databases.

15. The system of claim 12, wherein the controller removes from the pull file or list one or more of the computers or devices or entities on the pull file or list based on time expiration or an event.

16. A computer-implemented method for controlling access for networking computers or devices, the method comprising:
controlling, via a controller, access to a communications network or system, including one or more networking computers or devices;
specifying, via a push file or list, computers or devices or entities that can be granted access to the network or system;
specifying, via a pull file or list, computers or devices or entities that can be granted access to the network or system based on an access request to the controller;
granting or denying access, via the controller, to the computers or devices or entities on the push file or list without receiving the access request;
granting or denying access, via the controller, to the computers or devices or entities on the pull file or list, only after receiving the access request, and only if the computers or devices or entities on the pull file or list that requested the access are within control or jurisdiction of the controller;
if the computers or devices or entities on the pull file or list that requested the access are not within the control or jurisdiction of the controller, sending, via the controller, the access request to a higher level controller that has control or jurisdiction over the controller sending the access request; and
repeating the processing of the pull file or list until the computers or devices or entities on the pull file or list that requested the access are granted or denied access to the network or system.

17. The method of claim 16, further comprising providing plural levels of controllers with an access control policy associated with each level; and
making an access control policy for a lower level subordinate to an access control policy for a higher level.

18. The method of claim 16, further comprising:
specifying in a deny file computers or devices or entities that are not allowed access to the network or system; and
granting or denying access, via the controller, to the computers or devices or entities on the deny file or list and computers or devices or entities that are not on the push file or list, and the pull file or list.

19. The method of claim 18, wherein the push file or list, the pull file or list, and the deny file or list comprise individual or separate files or lists.

19. The method of claim 18, wherein the push file or list, the pull file or list, and the deny file or list are stored on individual or separate databases.

20. The method of claim 18, further comprising removing, via the controller, from the pull file or list one or more of the computers or devices or entities on the pull file or list based on time expiration or an event.

21. A computer program product for controlling access for networking computers or devices, and including one or more computer readable instructions embedded on a tangible computer readable medium and configured to cause one or more computer processors to perform the steps of:
controlling, via a controller, access to a communications network or system, including one or more networking computers or devices;
specifying, via a push file or list, computers or devices or entities that can be granted access to the network or system;
specifying, via a pull file or list, computers or devices or entities that can be granted access to the network or system based on an access request to the controller;
granting or denying access, via the controller, to the computers or devices or entities on the push file or list without receiving the access request;
granting or denying access, via the controller, to the computers or devices or entities on the pull file or list, only after receiving the access request, and only if the computers or devices or entities on the pull file or list that requested the access are within control or jurisdiction of the controller;
if the computers or devices or entities on the pull file or list that requested the access are not within the control or jurisdiction of the controller, sending, via the controller, the access request to a higher level controller that has control or jurisdiction over the controller sending the access request; and
repeating the processing of the pull file or list until the computers or devices or entities on the pull file or list that requested the access are granted or denied access to the network or system.

22. The computer program product of claim 21, further comprising providing plural levels of controllers with an access control policy associated with each level; and
making an access control policy for a lower level subordinate to an access control policy for a higher level.

23. The computer program product of claim 21, further comprising:
specifying in a deny file computers or devices or entities that are not allowed access to the network or system; and
granting or denying access, via the controller, to the computers or devices or entities on the deny file or list and computers or devices or entities that are not on the push file or list, and the pull file or list.

24. The computer program product of claim 23, wherein the push file or list, the pull file or list, and the deny file or list comprise individual or separate files or lists.

25. The computer program product of claim 23, wherein the push file or list, the pull file or list, and the deny file or list are stored on individual or separate databases.

26. The computer program product of claim 23, further comprising removing, via the controller, from the pull file or list one or more of the computers or devices or entities on the pull file or list based on time expiration or an event.
